(19) United States
(12) Patent Application Publication
(10) Pub. No.: US 2015/0165470 A1
(43) Pub. Date: Jun. 18, 2015

(54) DIE COATER AND METHOD FOR PRODUCING COATED FILM

(71) Applicant: FUJIFILM CORPORATION, Tokyo (JP)

(72) Inventors: Satoshi KUNIYASU, Kanagawa (JP); Yusuke IKEYAMA, Kanagawa (JP)

(73) Assignee: FUJIFILM CORPORATION, Tokyo (JP)

(21) Appl. No.: 14/566,065

(22) Filed: Dec. 10, 2014

(30) Foreign Application Priority Data
Dec. 13, 2013 (JP) 2013-257950

(51) Int. Cl. B05C 5/02; B05D 1/26

(52) U.S. Cl. CPC B05C 5/0254; B05D 1/26; B05C 5/0245

(57) ABSTRACT

The present invention provides a die coater which can improve a distribution of film thickness in the width direction of a coating, and can reduce the length of an end part of the coating, and a method for producing a coated film. The die coater includes: a main body of a die block, which has a manifold and a slit that communicates with the manifold and discharges a coating liquid therefrom; and spacers that are arranged on each of both end parts in a width direction of the slit and define a width of a flow channel of the coating liquid, wherein an area of a notch region in each spacer is larger than an area of a virtual triangle.

### CROSS-REFERENCE TO RELATED APPLICATIONS

The patent application claims priority under 35 U.S.C. §119 to Japanese Patent Application No. 2013-257950, filed on Dec. 13, 2013. The above application is hereby expressly incorporated by reference, in its entirety, into the present application.

### BACKGROUND OF THE INVENTION

1. Field of the Invention

The present invention relates to a die coater for forming a coating on a continuous substrate and a method for producing a coated film, which are technologies concerning improvement of the distribution of film thickness in a width direction of the coating.

2. Description of the Related Art

In various apparatuses such as a display device such as an optical element, a liquid crystal display and an organic EL (Electro-Luminescence) display, a semiconductor device and a thin-film solar cell, a coated film which has a coating formed on a substrate is used as a gas barrier film, a protective film, an optical compensation film, an antireflection film and the like.

A method of using a die coater is known as a method for forming the coating on the substrate. The die coater has a die block which has a manifold and a slit that communicates with the manifold. A spacer is inserted in both end parts of the slit of the die coater, in order to define the width of the coating to be formed on the substrate. The width of the slit is adjusted by the distance between the spacers. The substrate on which the coating is formed is continuously conveyed while being wound around a backup roller. A bead of a coating liquid which has been discharged from the slit is formed between the tip of the slit of the die coater and the substrate to be conveyed, and the coating is formed on the substrate through this bead. An upstream side of the die coater is kept in a state of a reduced pressure in order to stabilize the bead of the coating liquid.

The thickness of the coating is defined by a gap of the slit of the die coater. However, even if the slit is formed so as to have a uniform gap, there is a problem that the film thickness becomes thick on the end part in the width direction of the coating, as compared with the vicinity of the center of the coating. A method for improving such a problem has been proposed.

Japanese Patent Application Laid-Open No. 5-096223 discloses a slide bead application device in which an outflow width is widened to have an arc shape from the bottom part to the upper part of a cavity by a coating liquid outflow controlling member so that the outflow width is widened from the bottom part to the upper part in the slit. In addition, Japanese Patent Application Laid-Open No. 2000-260310 discloses that, when a paste is applied from a head having a discharge groove, the discharge groove is widened outward toward the tip of the discharge groove in the die coater. Thereby, the end part of the coated paste layer does not hump, and the coated paste layer having a uniform height can be formed on the whole surface.

### SUMMARY OF THE INVENTION

However, although Japanese Patent Application Laid-Open No. 5-096223 and Japanese Patent Application Laid-Open No. 2000-260310 aim to reduce the phenomenon that the thickness of the coating increases on the end part in a width direction of the coating, they cannot sufficiently work. In addition, in these methods, it has been found that the end part which cannot be used as a product results in being formed in a wide distance.

The present invention is designed with respect to such a circumstance, and an object is to provide a die coater which can reduce the distribution of film thickness in the width direction of the coating, and a method for producing a coated film.

A die coater according to the aspect of the present invention includes: a main body of a die block which includes a manifold and a slit that communicates with the manifold and discharges an coating liquid; and spacers each of which is arranged on each of both end parts in a width direction of the slit, and define a width of a flow channel of the coating liquid, wherein: each of the spacers has, from a supply side toward a discharge side of the coating liquid of the slit, a first face which defines a flow channel having a fixed width, a second face which is continuously connected to the first face and defines a flow channel having a width wider than the fixed width, and a third face which is continuously connected to the second face and constitutes a tip face; and when each of the spacer is viewed in a plan, assuming that an intersection point of a virtual extended line of the first face and a virtual extended line of the third face is defined as a reference intersection point, an intersection point of the first face and the second face is defined as a first intersection point, and an intersection point of the second face and the third face is defined as a second intersection point, an area of a notch region which is surrounded by a straight line formed by connecting the first intersection point and the reference intersection point, a straight line formed by connecting the reference intersection point and the second intersection point, and a continuous line along the second face, is larger than an area of a virtual triangle formed by connecting the reference intersection point, the first intersection point and the second intersection point.

A method for producing a coated film according to another aspect of the present invention includes: preparing a die coater that includes: a main body of a die block which includes a manifold and a slit that communicates with the manifold and discharges an coating liquid; and spacers each of which is arranged on each of both end parts in a width direction of the slit, and define a width of a flow channel of the coating liquid, wherein each of the spacers has, from a supply side toward a discharge side of the coating liquid of the slit, a first face which defines a flow channel having a fixed width, a second face which is continuously connected to the first face and defines a flow channel having a width wider than the fixed width, and a third face which is continuously connected to the second face and constitutes a tip face, and when each of the spacer is viewed in a plan, assuming that an intersection point of a virtual extended line of the first face and a virtual extended line of the third face is defined as a reference intersection point, an intersection point of the first face and the second face is defined as a first intersection point, and an intersection point of the second face and the third face is defined as a second intersection point, an area of a notch region which is surrounded by a straight line formed by connecting the first intersection point and the reference intersection point, a straight line formed by connecting the reference intersection point and the second intersection point, and a continuous line along the second face, is larger than an area of a virtual triangle formed by connecting the reference intersection point, the first intersection point and the second intersection point; conveying a continuous substrate; and forming a coating on the substrate by reducing a pressure from an atmospheric pressure in an upstream side of the die coater, keeping a state of the reduced pressure and discharging a coating liquid from the die coater.

A distance between the reference intersection point and the second intersection point is preferably longer than a distance between the reference intersection point and the first intersection point.

An application device and a method for producing the coated film of the present invention can reduce the distribution of the thickness in the width direction of the coating.

### BRIEF DESCRIPTION OF THE DRAWINGS

FIG. 1 is a schematic block diagram of an application system including a die coater;

FIG. 2 is a perspective view of the die coater;

FIG. 3 is a perspective view of spacers facing each other;

FIG. 4 is a plan view of the spacer;

FIG. 5 is a plan view of the spacer showing a size in a notch region of a first embodiment;

FIG. 6 is a plan view for describing a mechanism of the present embodiment;

FIG. 7 is a diagram illustrating the distribution of film thickness on an end part of a coated film;

FIG. 8 is plan views of the spacers of the first embodiment;

FIG. 9 is a plan view of a spacer showing a size of a notch region of a second embodiment;

FIG. 10 is plan views of the spacers of the second embodiment;

FIG. 11 is a schematic block diagram for describing a degree of a pressure reduction;

FIG. 12 is plan views showing shapes of spacers in comparative examples; and

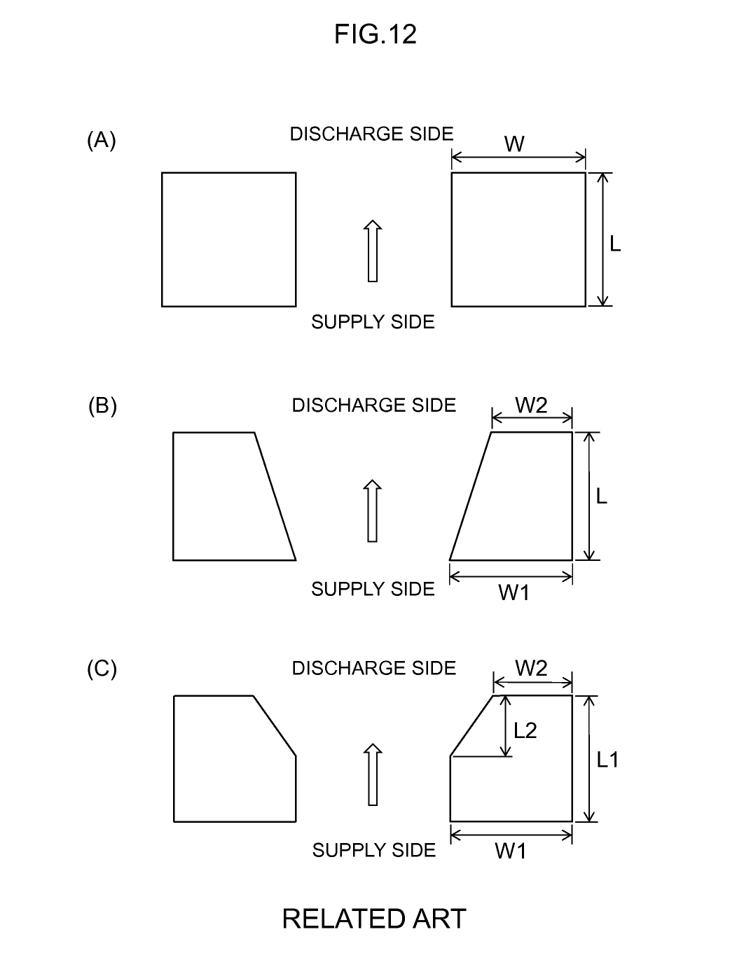

FIG. 13 is plan views showing shapes of spacers in examples.

### DETAILED DESCRIPTION OF THE PREFERRED EMBODIMENTS

Preferable embodiments according to the present invention are described below with reference to the attached drawings. The present invention is described with reference to the following preferable embodiments. The present invention can be modified by many techniques without exceeding the scope of the present invention, and can make use of other embodiments than the present embodiment. Accordingly, all modifications in the scope of the present invention are included in the claims.

Here, in the figure, portions designated by the same reference characters are similar elements having similar functions. In addition, in the present specification, when a range of numeric values is expressed by “to”, the numerical values of the lower limit and the upper limit expressed by “to” shall be also included in the range of the numeric values.

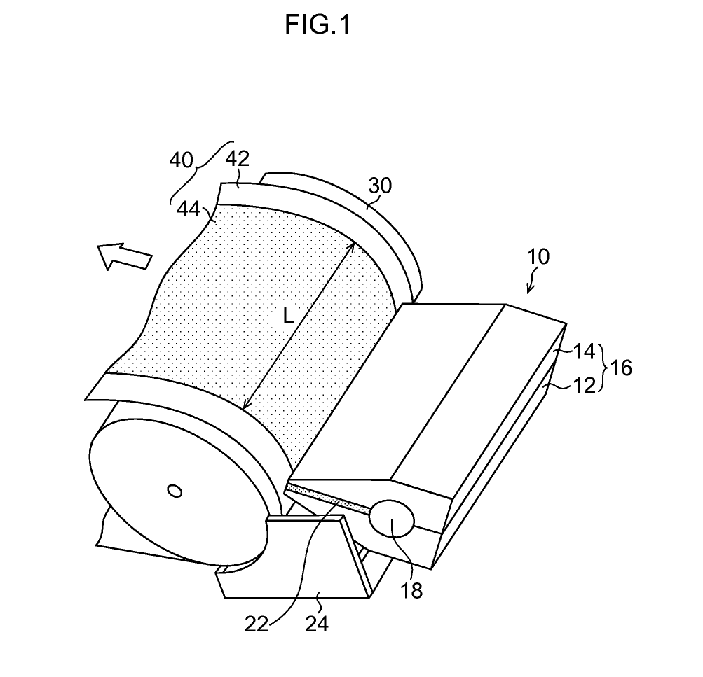

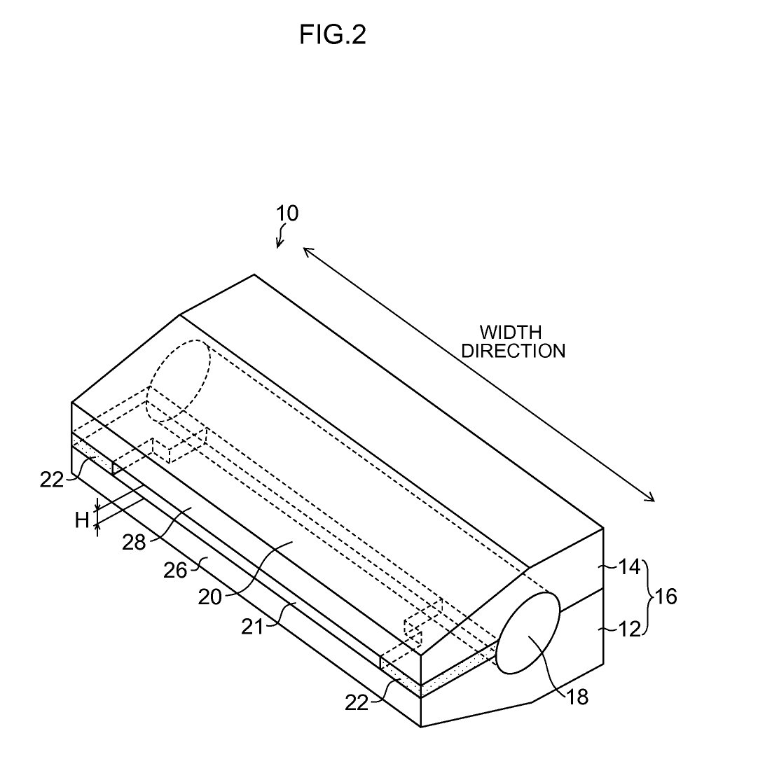

FIG. 1 is a perspective view of an application system including a die coater, and FIG. 2 is a perspective view of the die coater. As is shown in FIG. 1, the die coater 10 is arranged so that a discharge side from which the coating liquid is discharged faces a substrate 42. A backup roller 30 is arranged in a side of a surface of the substrate 42 opposite to a surface on which a coating 44 is to be formed. The backup roller 30 is rotatably structured, and accordingly can support the substrate 42 to be conveyed. A tensile force is given to the substrate 42 by an unshown winding device and an unshown feed roller, and accordingly the substrate 42 is continuously conveyed in a direction shown by the arrow. The coating 44 is formed on the substrate 42 by the die coater 10, and thereby the coated film 40 is produced.

The coating liquid which has been supplied to the die coater 10 is fed to a manifold 18. A method for feeding the coating liquid to the manifold 18 includes a method of supplying the coating liquid from the central part of the manifold 18 and distributing the coating liquid to both sides, and a method of supplying the coating liquid from one side of the manifold 18 and extracting the coating liquid from the other side, in addition to a method of blocking one end side of the manifold 18 and supplying the coating liquid from the other end side. Any of one of the methods may be applied. In the die coater 10, a slit 20 and/or a side plate (unshown) which covers the manifold 18 are arranged as needed.

The coating liquid which has been sent to the manifold 18 is supplied onto the substrate 42 through the slit 20 that communicates with the manifold 18. The discharge side of the slit 20 of the die coater 10 and the substrate 42 are arranged so as to face to each other while being separated by a gap, for instance, of 30 μm to 300 μm. The tip of the die coater 10, specifically, a discharge port 21 of the slit 20 has a flat upstream lip 26 and a flat downstream lip 28. The upstream lip 26 and the downstream lip 28 are not limited to the flat shape.

When the coating liquid is discharged from the slit 20, a bead is formed between the discharge side of the slit 20 of the die coater 10 and the substrate 42. The coating liquid is applied onto the substrate 42 through the bead, and thereby a coating 44 is formed on the substrate 42. In order to stabilize the shape of the bead, a state where a pressure is reduced from the atmospheric pressure is kept in the upstream side of the application position in a conveyance direction of the substrate 42. The reduced pressure state is kept by a pressure reducing chamber 24 which is arranged in the upstream side of the die coater 10.

Incidentally, as for the position, a direction in which the substrate 42 is conveyed from a certain reference point is referred to as “toward downstream direction” or “downstream side”, and an opposite direction to the direction in which the substrate 42 is conveyed from the certain reference point is referred to as “toward upstream direction” or “upstream side”.

The die coater 10 is provided with a first block 12 and a second block 14. The die block main body 16 is structured by the first block 12 and the second block 14. The first block 12 and the second block 14 have each a space in its inside. The manifold 18 and the slit 20 are formed by combining the first block 12 and the second block 14. The manifold 18 is a space extending along the width direction of the die coater 10, which is formed in the inside of the die block main body 16. The coating liquid is temporarily stored in the manifold 18. The slit 20 is a space which communicates with the manifold 18, and extends in a direction toward the tip of the die coater 10 from the manifold 18, along the width direction of the die coater 10. The slit 20 is opened to the outside at the tip of the die coater 10, and accordingly functions as the discharge port 21 of the coating liquid. By being structured as in the above description, the manifold 18 and the slit 20 are formed in the die block main body 16. In the present embodiment, the die block main body 16 is structured by two die blocks of the first block 12 and the second block 14. The die block main body 16 can be structured even by one die block, or by three or more die blocks.

The die coater 10 is provided with spacers 22 which are arranged on both end parts in the width direction of the slit 20, respectively. The spacers 22 control a width L of a coating 44 to be formed on the substrate 42. A flow channel of the coating liquid which is supplied to the substrate 42 from the die coater 10 is defined by the two spacers 22 which face to the slit 20. A gap H of the slit 20 is defined by a distance between the first block 12 and the second block 14. The gap H of the slit 20 becomes a factor which specifies the thickness of the coating 44. However, even if the gap H of the slit 20 has been specified, a thick film part is formed in the end part of the coating 44. The width of the flow channel of the coating liquid is defined by the distance between the pair of spacers 22 which are arranged so as to face to each other.

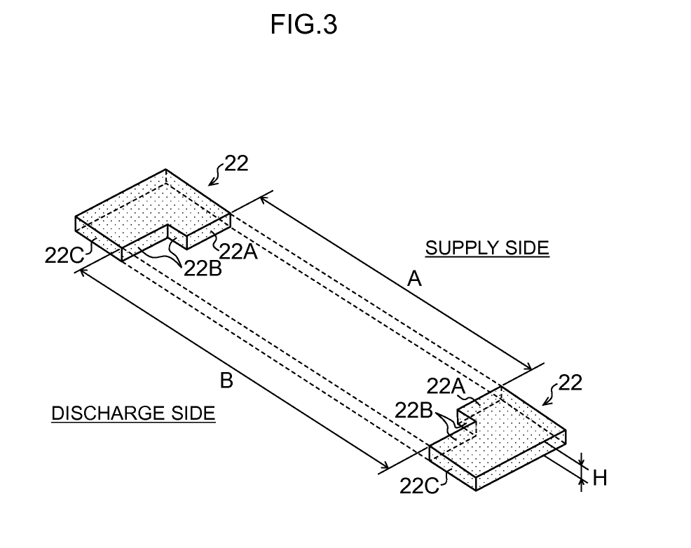

FIG. 3 is a perspective view of the pair of spacers 22. The thickness of the spacer 22 basically coincides with the gap H of the slit 20. The pair of spacers 22 have each a first face 22A which is oriented from a supply side of the coating liquid toward a discharge side of the slit 20, and defines a flow channel having a fixed width A. The first face 22A is formed of a plane or an approximate plane, and the facing first faces 22A are parallel or approximately parallel to each other. Thereby, the flow channel having the fixed width A is defined.

The spacers 22 have each a second face 22B which is continuously connected to the first face 22A and defines a flow channel having a width B. The distance between the facing second faces 22B is longer than the distance between the facing first faces 22A. Accordingly, the flow channel having the width B which is wider than the fixed width A that is defined by the first face 22A can be defined by the second faces 22B. The second face 22B may be formed by a plurality of faces, or may also be formed by a curved surface which forms an arc when viewed in a plan (in a plan view). There is no necessity for the width B to be the fixed width, as long as the width B is wider than the width A. “Plane view” for the spacer 22 means that the spacer 22 is viewed from above in the state in which the largest surface of the spacer 22 is horizontally placed.

The spacers 22 have each a third face 22C which is continuously connected to the second face 22B. The third face 22C constitutes a tip face which is a face facing the substrate 42 to be conveyed.

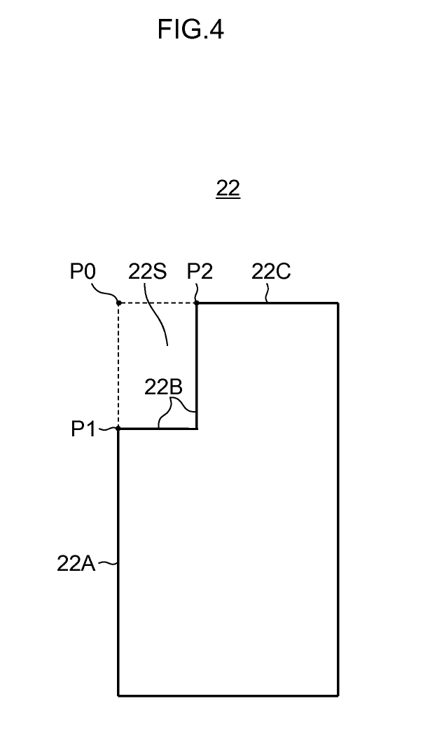

The spacer 22 of the present embodiment has a characteristic structure when viewed in a plan. As is shown in FIG. 4, when the spacer is viewed in a plan, and when an intersection point of a virtual extended line of the first face 22A and a virtual extended line of the third face 22C is defined as a reference intersection point P0, an intersection point of the first face 22A and the second face 22B is defined as a first intersection point P1, and an intersection point of the second face 22B and the third face 22C is defined as a second intersection point P2, the spacer 22 of the first embodiment has an area in a notch region 22S which is surrounded by a straight line formed by connecting the first intersection point P1 and the reference intersection point P0, a straight line formed by the reference intersection point P0 and the second intersection point P2, and a continuous line along the second face 22B.

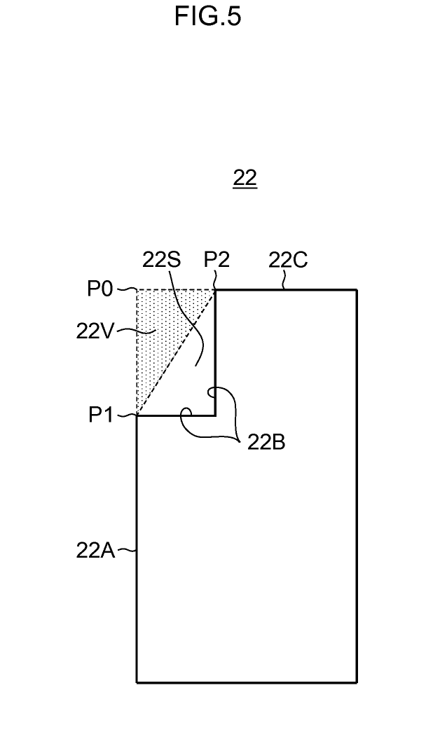

As is shown in FIG. 5, the notch region 22S of the spacer 22 has an area larger than an area of a virtual triangle 22V which is formed by connecting the reference intersection point P0, the first intersection point P1 and the second intersection point P2. In other words, the second face 22B of the spacer 22 is formed so that the area of the notch region 22S becomes larger than the area of the virtual triangle 22V.

Incidentally, in FIG. 4 and FIG. 5, the spacer 22 is viewed in the plane, and accordingly when the first face 22A and the third face 22C are virtually extended, the extended faces are expressed as extended lines. The intersection point of the extended lines is expressed as the reference intersection point P0. The nordal line of the first face 22A and the second face 22B is expressed as the first intersection point P1, and the nordal line of the second face 22B and the third face 22C is expressed as the second intersection point P2. As for the second face 22B, the face is expressed as a continuous line along the second face 22B.

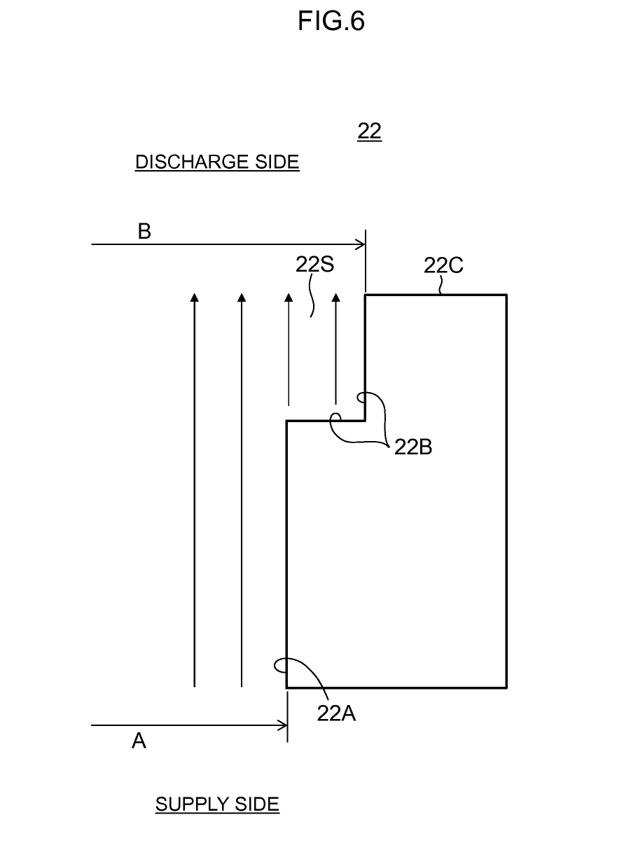

Next, the function of the spacer 22 in the first embodiment is described below with reference to FIG. 6. As shown in FIG. 6, the spacers 22 each having the notch region 22S are provided on both end parts of the slit 20.

Due to this spacer 22, in the discharge side, the width B of the flow channel is wider than the width A of the flow channel in the supply side. On both end parts in the width direction of the slit 20, the coating liquid flows into the notch region 22S, and after that, the coating liquid is discharged from the tip of the slit 20. On the other hand, in the region except the vicinity of both end parts of the slit 20, the coating liquid is discharged as-is from the tip of the slit 20. In the present embodiment, the area of the notch region 22S is set to be larger than that of the virtual triangle 22V. Accordingly, in the present embodiment, a more amount of coating liquid flows into the notch region 22S than the case where the area of the notch region 22S is the same as the area of the virtual triangle 22V. Accordingly, the flow velocity of the coating liquid can be made slower in the vicinity of both end parts of the slit 20 than that in the region except the vicinity of both end parts of the slit 20. Because of this, the discharge amount per unit time can be decreased in the vicinity of both end parts of the slit 20, and the problem that the coating becomes thick can be suppressed. Incidentally, in FIG. 6, the arrow from the bottom to the top shows a flow direction of the coating liquid.

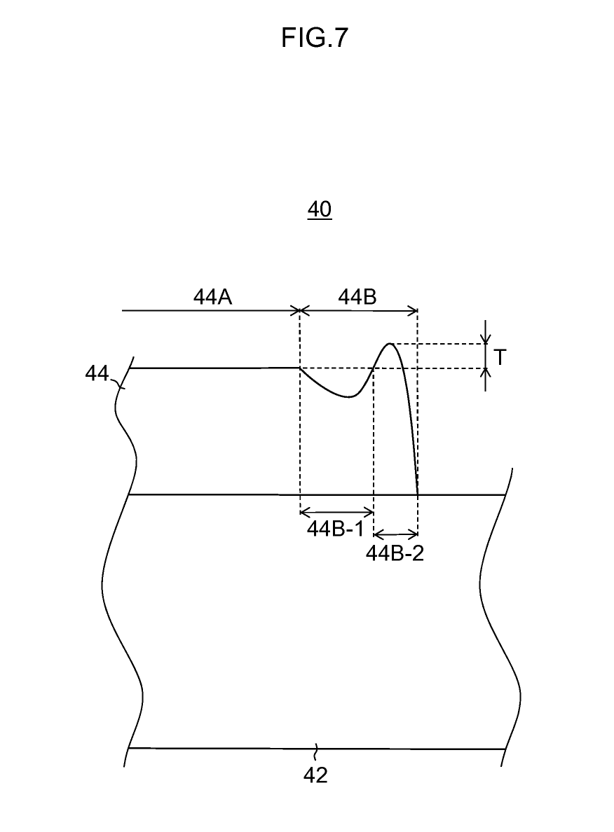

FIG. 7 is an enlarged view of the end part of the coated film 40 which has been formed in the present embodiment. Incidentally, the end part of the coated film 40 is an enlarged view showing the coating 44 which has been dried. As is shown in FIG. 7, the coating 44 is formed of a regular part 44A which is to be used as a product, and an end part 44B which is not used as the product. Furthermore, the end part 44B is formed of a thin film part 44B-1 and a thick film part 44B-2. As for the end part 44B, as long as the thick film part 44B-2 is formed, the thin film part 44B-1 is formed between the regular part 44A and the thick film part 44B-2. The positions and the lengths of the regular part 44A and the end part 44B (thin film part 44B-1 and thick film part 44B-2) can be measured by an optical interference-type thickness meter or a contact type thickness meter.

Due to the spacer 22 of the present embodiment, the discharge amount of the coating liquid decreases on both end parts of the discharge side of the slit 20, and accordingly the thickness of the thick film part 44B-2 can be decreased. Thereby, a difference T between the regular part 44A of the coating 44 and the end part 44B of the coating 44 can be decreased. Because the difference T can be decreased, the thickness distribution can be improved.

The shorter the length of the end part 44B is, the longer the length of the regular part 44A can be made. In other words, a region which can be used as a product can be increased, and accordingly a yield of the coated film 40 can be enhanced. For this purpose, the length of the thin film part 44B-1 is shortened, which leads the shortening of the length of the end part 44B.

In the present embodiment, the area of the notch region 22S is set to be larger than the area of the virtual triangle 22V. As a result, the distance between the reference intersection point P0 and the first intersection point P1 can be shortened. By shortening the distance between the reference intersection point P0 and the first intersection point P1, the length of the thin film part 44B-1 can be shortened.

The distance between the reference intersection point P0 and the first intersection point P1 determines a position at which the expansion of the width of the flow channel starts. As the starting position is closer to the discharge side of the coating liquid, the flow velocity distribution of the coating liquid occurs at a position closer to the discharge side. In other words, when the flow velocity distribution is generated late, the coating liquid having the small flow velocity is applied onto the substrate 42 during a short time period. Thereby, the length of the coating liquid having the small flow velocity in the width direction, specifically, the thin film part 44B-1 can be shortened.

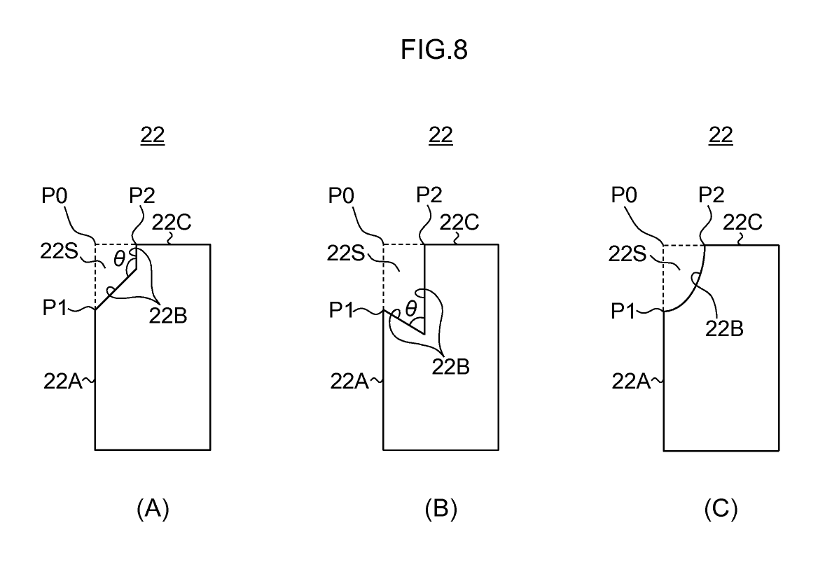

FIG. 8 shows representative shapes of the spacers 22 included in the first embodiment. In portion (A) of FIG. 8, the spacer 22 has the two second faces 22B. An angle θ formed by the two second faces 22B is an obtuse angle. In portion (B) of FIG. 8, the spacer 22 has two second faces 22B. An angle θ formed by the two second faces 22B is an acute angle. In portion (C) of FIG. 8, the spacer 22 has one second face 22B. The one second face 22B is formed of a curved surface. In any one of cases shown in portions (A) to (C) of FIG. 8, the area of the notch region 22S is larger than the area of the virtual triangle 22V.

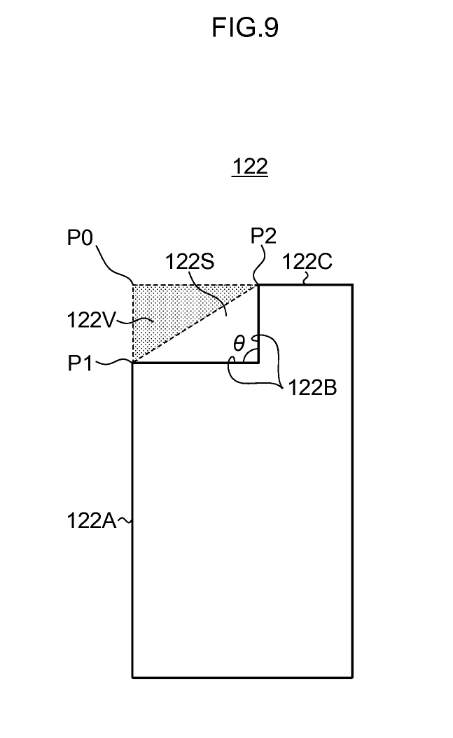

FIG. 9 is a plan view of a spacer according to a second embodiment. As is shown in FIG. 9, similarly to the spacer 22 of the first embodiment, in a plan view of the spacer, when an intersection point of a virtual extended line of a first face 122A and a virtual extended line of a third face 122C is defined as a reference intersection point P0, an intersection point of the first face 122A and a second face 122B is defined as a first intersection point P1, and an intersection point of the second face 122B and the third face 122C is defined as a second intersection point P2, a spacer 122 of the second embodiment has a notch region 122S which is surrounded by a straight line formed by connecting the first intersection point P1 and the reference intersection point P0, a straight line formed by the reference intersection point P0 and the second intersection point P2, and a continuous line along the second face 122B. The notch region 122S of the spacer 122 has an area larger than an area of a virtual triangle 122V which is formed by connecting the reference intersection point P0, the first intersection point P1 and the second intersection point P2. In the spacer 122 of the second embodiment, a distance between the first intersection point P1 and the reference intersection point P0 is set to be shorter than a distance between the second intersection point P2 and the reference intersection point P0.

When the notch region 22S of the spacer 22 and the notch region 122S of the spacer 122 are supposed to have the same area, the distance between the reference intersection point P0 and the first intersection point P1 in the spacer 122 of the second embodiment becomes shorter than that in the spacer 22 of the first embodiment. As a result, the thin film part 44B-1 can be more shortened.

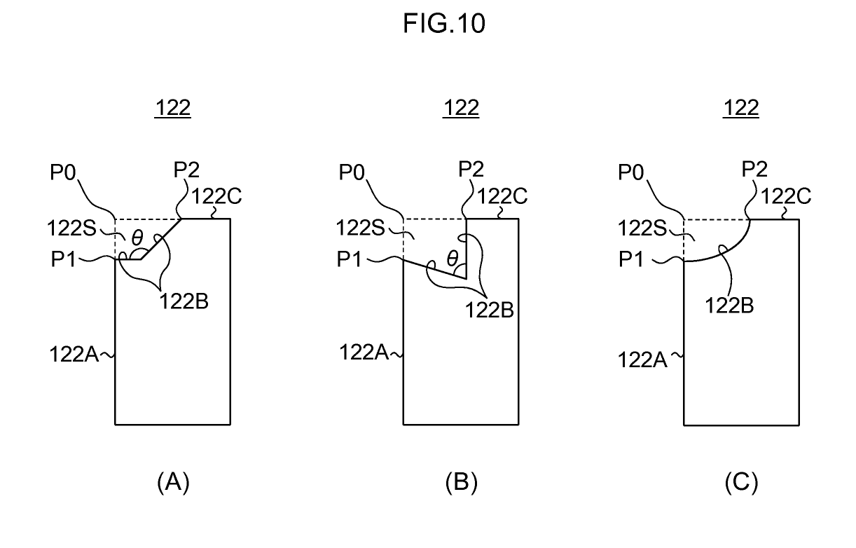

FIG. 10 shows representative shapes of the spacers 122 included in the second embodiment. In portion (A) of FIG. 10, the spacer 122 has two second faces 122B. An angle θ formed by the two second faces 122B is an obtuse angle. In portion (B) of FIG. 10, the spacer 122 has two second faces 122B. An angle θ formed by the two second faces 122B is an acute angle. In portion (C) of FIG. 10, the spacer 122 has one second face 122B. The one second face 122B is formed of a curved surface. In any one of cases shown in portions (A) to (C) of FIG. 10, the area of the notch region 122S is larger than the area of the virtual triangle 122V.

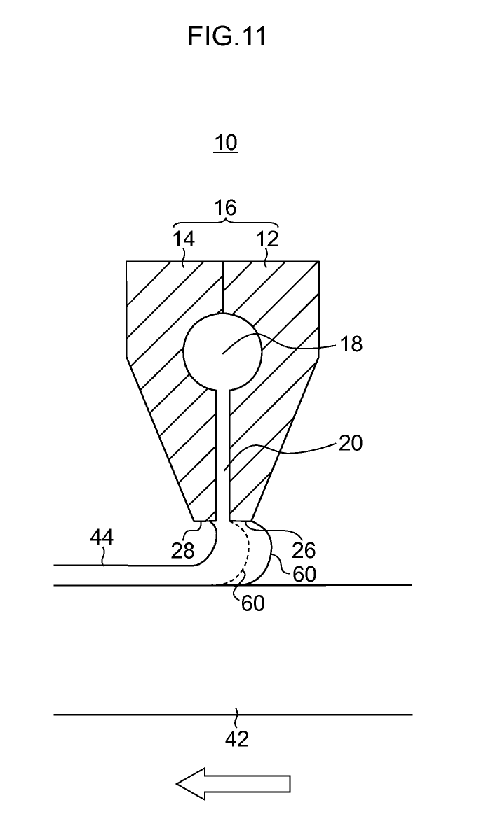

Next, in the present embodiment, the pressure reduction degree (differential pressure from the atmospheric pressure) by a pressure reducing chamber 24 is preferably within a range from 20% or more of the upper limit of the pressure reduction degree to the upper limit of the pressure reduction degree or less. FIG. 11 is a sectional view of the die coater 10. The upper limit of the pressure reduction degree means a state in which a meniscus 60 of the coating liquid comes in contact with the end part in the upstream side of the upstream lip 26. The lower limit of the pressure reduction degree means a state in which the meniscus 60 of the coating liquid shown by a dotted line comes in contact with the end part in the downstream side of the upstream lip 26. The pressure reduction degree is preferably large, is preferably 20% or more of the upper limit of the pressure reduction degree, more preferably is 50% or more of the upper limit of the pressure reduction degree, and further preferably is 80% or more of the upper limit of the pressure reduction degree. This is because the thickness of the thick film part 44B-2 can be decreased by increasing the pressure reduction degree.

The substrate 42 which is used in the present embodiment is not limited in particular. A resin film, a metal film or glass can be used, or these materials can be used in combination. The resin film is formed from, for instance, a resin such as polyethylene terephthalate (PET), polyethylene naphthalate (PEN), triacetyl cellulose (TAC), a cycloolefin polymer (COP) and a cycloolefin copolymer (COC). The substrate 42 may contain another component, in addition to a main component (resin, metal or glass, or combination of these materials).

The coating liquid which is used in the present embodiment is not limited in particular. The viscosity of the coating liquid is not limited as well in particular, but when the coating liquid has a viscosity of 10 to 500 mPa·s, it is preferable to apply the present embodiment. When the coating liquid having the viscosity of 10 to 500 mPa·s is used, the thickness of the coating of the end part tends to increase, but the increase of the thickness of the coating of the end part can be suppressed when the present embodiment is applied. Incidentally, the viscosity of the coating liquid can be measured by a Brookfield type viscometer.

Next, a method for producing the coated film 40 is described below with reference to FIG. 1 and FIG. 5. The die coater 10 is prepared that includes: the die block main body 16 which has the manifold 18 and the slit 20 that communicates with the manifold 18 and discharges the coating liquid therefrom; and the spacers 22 which are arranged on both end parts in the width direction of the slit 20 and define the width of the flow channel of the coating liquid. The spacer 22 has a shape in which the area of the notch region 22S is larger than the area of the virtual triangle 22V. The spacer 122 can be used in place of the spacer 22. When the continuous substrate 42 is conveyed, the substrate 42 is preferably conveyed while being supported by the backup roller 30. A pressure in the upstream side of the die coater 10 can be reduced from the atmospheric pressure by the pressure reducing chamber 24. The coating 44 is formed on the substrate 42 by the coating liquid discharged from the die coater 10. The coated film 40 is produced through these processes.

### EXAMPLE

Next, the present invention is described more specifically with reference to an example, but the present invention is not limited to the example.

### Application Method

The substrate, the die coater, the shape of the spacer, the coating condition and the coating liquid which were used in the examples are as follows. A PET (polyethylene terephthalate) film having a width of 1,500 mm and a thickness of 100 μm was used as the substrate.

A die coater was used which had a slit with a gap H of 150 μm and had two spacers. The distance between the spacers (so-called coating width) in the discharge side was set at 1,470 mm. A coating liquid for a hard coat layer was used as the coating liquid.

### Preparation of Coating Liquid for Hard Coat Layer

The following composition was charged into a mixing tank, was stirred, was filtered with a filter which had a pore diameter of 0.4 μm and was made from polypropylene to obtain a coating liquid for a hard coat layer (solid concentration of 65 mass % and viscosity of 15 mPa·s).

| | |
|---|---|
| Solvent (described in Table 1) | 21.0 parts by mass (total amount |
| | in the case of two or more types) |
| (a) Monomer: PET30 | 22.52 parts by mass |
| (b) Monomer: urethane monomer | 6.30 parts by mass |
| Photoinitiator (IRGACURE (trademark) | 0.84 parts by mass |
| 184, made by Ciba Specialty Chemicals | |
| Inc.) | |
| Leveling agent (SP-13) | 0.006 parts by mass |

The compounds which were each used are described below.

### Leveling Agent (SP-13)

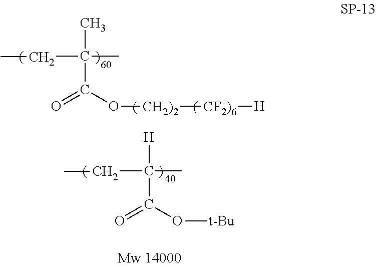

PET30: made by Nippon Kayaku Co., Ltd., mixture of compounds each having following structure. Average molecular weight is 298, and number of functional groups in one molecule is 3.4 (average).

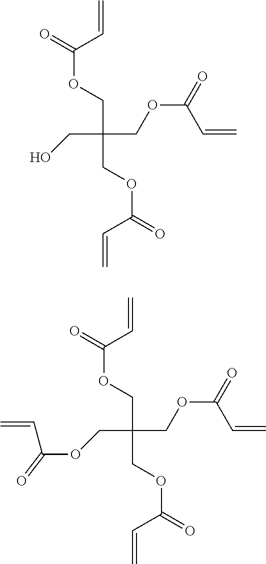

Urethane monomer: compound having following structure. Average molecular weight is 596, and number of functional groups in one molecule is 4.

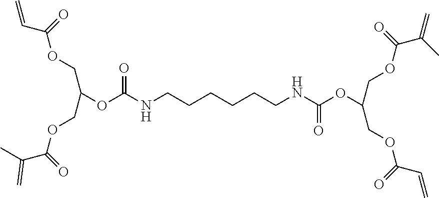 [SMILES: C=CC(=O)OCC(COC(=O)C(=C)C)OC(=O)NCCCCCCNC(=O)OC(COC(=O)C=C)COC(=O)C(=C)C]

Furthermore, the concentration of the solid content was changed, and coating liquids having viscosities of 100 mPa·s and 500 mPa·s were each prepared. The discharge amount was adjusted so that the amount of the coating liquid discharged from the die coater could form a coating having a wet thickness (thickness in a wet state) of 10 to 50 μm.

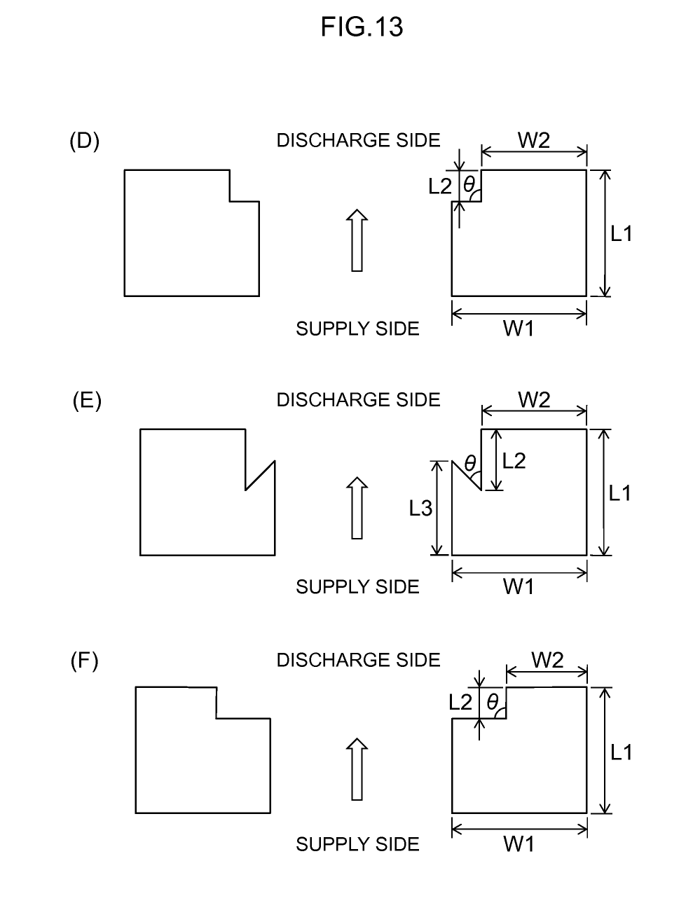

The coated film was produced by applying the coating liquid for the hard coat layer with the use of the die coater onto the continuously running substrate which was wound around and was supported by the backup roller, and then by drying the coated liquid so that the coating after drying had the thickness of 5 to 25 μm in the regular part. A plurality of spacers having different shapes were prepared, and the spacers were arranged on both end parts of the slit, respectively, when the coating liquid was applied. The shapes of the spacers in a comparative examples were shown in Fig. as shapes (A) to (C). The shapes of the spacers in the examples were shown in FIG. 13 as shapes (D) to (F). Each size of each spacer was shown below. In the comparative examples, the size of the shape (A) was W: 50 mm and L: 50 mm. The size of the shape (B) was W1: 50 mm, W2: 5 mm, and L: 50 mm. The size of the shape (C) was W1: 50 mm, W2: 5 mm, L1: 50 mm, and L2: 10 mm.

In the examples, the size of the shape (D) of the example was W1: 50 mm, W2: 5 mm, L1: 50 mm, L2: 5 mm, and θ: 90°. The size of the shape (E) was W1: 50 mm: W2: 5 mm, L1: 50 mm, L2: 10 mm, L3: 45 mm, and θ: 45°. The size of the shape (F) was W1: 50 mm, W2: 10 mm, L1: 50 mm, L2: 2.5 mm, and θ: 90°.

### Evaluation Method

The wet thickness (thickness in a wet state) of the applied coating is measured with the optical interference-type thickness meter to obtain the thickness in the regular part 44A, the thickness in the end part 44B and the difference T in thickness between the regular part 44A and the end part 44B. Further, and the length of the thin film part (44B-1) was measured. The total evaluation was performed based on each of the measurement results. The condition and the evaluation result are shown in Table 1. In the case where the difference T satisfies a range less than 8 μm and the length of the thin film part (44B-1) satisfies a range of 6 mm or less, the die coater was evaluated to be G. In the case where any one of the conditions was not satisfied, the coating was evaluated to be NG.

TABLE 1

| | | | Wet film | | | | |
|---|---|---|---|---|---|---|---|
| | | Liquid | thickness | Pressure | Evaluation result | | |
| | | viscosity | in regular | reduction degree | Difference T | 44B-1 | Total |
| | Shape | [mPa · s] | part [μm] | [—] | (μm) | (mm) | evaluation |
| Comparative | Shape (A) | 15 | 30 | 20% of upper | 9 | 3 | NG |
| Example 1 | | | | limit | | | |
| Comparative | Shape (B) | 15 | 30 | 20% of upper | 7 | 21 | NG |
| Example 2 | | | | limit | | | |
| Comparative | Shape (C) | 15 | 30 | 20% of upper | 8 | 6 | NG |
| Example 3 | | | | limit | | | |
| Example 1 | Shape (D) | 15 | 30 | 20% of upper | 2 | 6 | G |
| | | | | limit | | | |
| Example 2 | Shape (E) | 15 | 30 | 20% of upper | 1 | 5 | G |
| | | | | limit | | | |
| Example 3 | Shape (F) | 15 | 30 | 20% of upper | 1 | 4 | G |
| | | | | limit | | | |
| Example 4 | Shape (E) | 100 | 30 | 20% of upper | 3 | 5 | G |
| | | | | limit | | | |
| Example 5 | Shape (E) | 500 | 30 | 20% of upper | 4 | 5 | G |
| | | | | limit | | | |
| Example 6 | Shape (E) | 15 | 50 | 20% of upper | 2 | 6 | G |
| | | | | limit | | | |
| Example 7 | Shape (E) | 15 | 10 | 20% of upper | 0 | 4 | G |
| | | | | limit | | | |
| Example 8 | Shape (D) | 15 | 30 | 50% of upper | 1.5 | 6 | G |
| | | | | limit | | | |
| Example 9 | Shape (D) | 15 | 30 | 80% of upper | 1 | 6 | G |
| | | | | limit | | | |

As is shown in Table 1, the distribution of the film thickness can be improved by using the spacer of the present embodiment (examples 1 to 9), as compared with the case where a conventional spacer (comparative examples 1 to 3) is used.

What is claimed is:

1. A die coater comprising:
a main body of a die block which includes a manifold and a slit that communicates with the manifold and discharges an coating liquid; and
spacers each of which is arranged on each of both end parts in a width direction of the slit, and define a width of a flow channel of the coating liquid, wherein
each of the spacers has, from a supply side toward a discharge side of the coating liquid of the slit, a first face which defines a flow channel having a fixed width, a second face which is continuously connected to the first face and defines a flow channel having a width wider than the fixed width, and a third face which is continuously connected to the second face and constitutes a tip face, and
when each of the spacer is viewed in a plan, assuming that an intersection point of a virtual extended line of the first face and a virtual extended line of the third face is defined as a reference intersection point, an intersection point of the first face and the second face is defined as a first intersection point, and an intersection point of the second face and the third face is defined as a second intersection point, an area of a notch region which is surrounded by a straight line formed by connecting the first intersection point and the reference intersection point, a straight line formed by connecting the reference intersection point and the second intersection point, and a continuous line along the second face, is larger than an area of a virtual triangle formed by connecting the reference intersection point, the first intersection point and the second intersection point.

2. The die coater according to claim 1, wherein a distance between the reference intersection point and the second intersection point is longer than a distance between the reference intersection point and the first intersection point.

3. A method for producing a coated film comprising:
preparing a die coater that includes:
a main body of a die block which includes a manifold and a slit that communicates with the manifold and discharges an coating liquid; and
spacers each of which is arranged on each of both end parts in a width direction of the slit, and define a width of a flow channel of the coating liquid, wherein
each of the spacers has, from a supply side toward a discharge side of the coating liquid of the slit, a first face which defines a flow channel having a fixed width, a second face which is continuously connected to the first face and defines a flow channel having a width wider than the fixed width, and a third face which is continuously connected to the second face and constitutes a tip face, and
when each of the spacer is viewed in a plan, assuming that an intersection point of a virtual extended line of the first face and a virtual extended line of the third face is defined as a reference intersection point, an intersection point of the first face and the second face is defined as a first intersection point, and an intersection point of the second face and the third face is defined as a second intersection point, an area of a notch region which is surrounded by a straight line formed by connecting the first intersection point and the reference intersection point, a straight line formed by connecting the reference intersection point and the second intersection point, and a continuous line along the second face, is larger than an area of a virtual triangle formed by connecting the reference intersection point, the first intersection point and the second intersection point;
conveying a continuous substrate; and
forming a coating on the substrate by reducing a pressure from an atmospheric pressure in an upstream side of the die coater, keeping a state of the reduced pressure and discharging a coating liquid from the die coater.

4. The method for producing the coated film according to claim 3, wherein a distance between the reference intersection point and the second intersection point is longer than a distance between the reference intersection point and the first intersection point.
